(19) United States
(12) Patent Application Publication
(10) Pub. No.: US 2006/0052579 A1
(43) Pub. Date: Mar. 9, 2006

(54) Polymers bridged by a transition metal

(75) Inventors: Ralf Noerenberg, INGELHEIM (DE); Norbert Wagner, Mutterstadt (DE); Minica Fernandez Gonzalez, Heidelberg (DE); Ulrich S. Schubert, Ismaning (DE); Stefan Schmatloch, Eindhoven (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 10/532,723

(22) PCT Filed: Oct. 24, 2003
(86) PCT No.: PCT/EP03/11852

§ 371 Date: Apr. 27, 2005

(30) Foreign Application Priority Data
Oct. 28, 2002 (DE) 102 50 274.9

(51) Int. Cl. C08G 73/06; C08F 6/00; C08L 57/12

(52) U.S. Cl. 528/423; 528/492; 525/540

(57) ABSTRACT

In the polymer of transition-metal-bridged units of the formula (I) 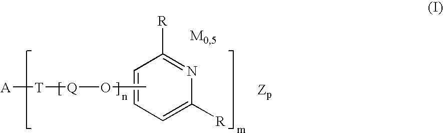 where A is an m-valent organic radical, T independently of one another are O or NH,
Q independently of one another are CHR¹—CH₂ where R¹ is H or optionally substituted C₁₋₆-alkyl, R independently of one another are H, 2-pyridyl, 2-imidazolinyl, 2-imidazolyl, 2-thiazolinyl, 2-thiazolyl, 2-pyridazyl, 2-pyrimidyl, carboxyl, carboxylic ester radical, carboxamide radical, carboxylate, phosphonate, where at least one of the radicals R is different from H,
M is Fe²⁺, Fe³⁺, Co²⁺, Co³⁺, Zn²⁺, Ru²⁺, Os²⁺, Ni²⁺,
Z is SO₄²⁻, CH₃OO⁻, BF₄⁻, SF₆⁻, Cl⁻, I⁻, PF₆⁻, perchlorate, n is 1 to 10 000, m is 2 to 100, p is a number which corresponds to the charge balance within the polymer, the average molecular weight of the polymer is at least 15 000.

The invention relates to polymers of transition-metal-bridged units, to processes for their preparation and to their use for increasing the viscosity of liquids, which can be combined with a simultaneous imparting of color to the liquid. The invention also relates to the use of the polymers as switchable gelling agents or hydrogels.

For many applications such as shampoos or shower gels in the cosmetics industry, spray cleaners or fabric softeners in the laundry detergent and cleaner industry or lacquers and paints in the coatings industry, high-viscosity solutions are very interesting systems. It is desirable to achieve a high viscosity in these solutions using the smallest possible amount of thickeners or hydrogels. At the present time, use is often made of polyacrylic acid as thickener. However, due to the poor compatibility with anionic surfactants, recourse must frequently be had to complex and costly biopolymers, such as alginates, xanthans, or to high molecular weight nonionic polymers, such as polyvinylpyrrolidone or polyethylene oxide. Viscosities of about 1 000 mPas are often achieved with a concentration of less than 1% of the polymer in water. To color the gels, the addition of a dye is necessary, and the viscosity can only be modulated as a result of a dilution.

Alternatively to this, hydrophobically modified, shorter-chain polymers are used as associating thickeners, which are able to build up a pseudoplasticity by forming a network, optionally together with surfactants. Such formulations are not easy to change and adapt either since virtually every formulation constituent influences the efficiency of the network formation. The viscosity of oils and solvents can also be changed through the formation of a hydrogen bridging network.

Polymer Preprints 2000, 41 (1), pages 542 to 543 describes functional (block) copolymers with metallic complexing segments. These are bisterpyridine-terminated polyethylene oxides which can be bridged using transition metal ions and thereby polymerized. Polymer Preprints 2001, 42(2), pages 395 to 396 relates to similar polymer systems. The change in the viscosity during the gradual addition of metal ions is described. When a metal salt was added slowly, there was an increase in the viscosity. The viscosity values which can be achieved with this process, however, are very low and are less than 40 mPas with a 4% strength solution of the polymer in water. The polymers obtained by the process achieve an inadequately high molecular weight and can thus not be used as thickeners.

It is an object of the present invention to provide polymers of transition-metal-bridged units which have a higher molecular weight and thus exhibit viscosity values which make them suitable for use as thickeners.

Surprisingly, we have found that this object is achieved by a polymer of transition-metal-bridged units of the formula (I)

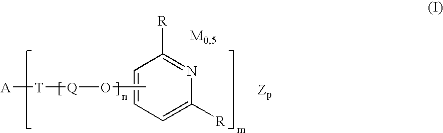

where

A is an m-valent organic radical,

T independently of one another are O or NH,

Q independently of one another are CHR¹—CH₂ where R¹ is H or optionally substituted C₁₋₆-alkyl,

R independently of one another are H, 2-pyridyl, 2-imidazolinyl, 2-imidazolyl, 2-thiazolinyl, 2-thiazolyl, 2-pyridazyl, 2-pyrimidyl, carboxyl, carboxylic ester radical, carboxamide radical, carboxylate, phosphonate, where at least one of the radicals R is different from H,

M is Fe²⁺, Fe³⁺, Co²⁺, Co³⁺, Zn²⁺, Ru²⁺, Os²⁺, Ni²⁺,

Z is SO₄²⁻, CH₃OO⁻, BF₄⁻, SF₆⁻, Cl⁻, I⁻, PF₆⁻, perchlorate,

n is 1 to 10 000,

m is 2to 100,

p is a number which corresponds to the charge balance within the polymer,

where the average molecular weight of the polymer is at least 15 000.

In the polymers according to the invention, the average molecular weight (number-average) is at least 15 000, preferably at least 30 000, particularly preferably at least 200 000.

The viscosity of a 10% strength by weight aqueous solution of the polymer is more than 1 000 mPas, whereas according to the polymers obtained in Polymer Preprints 2000, 41(1), 542 and Polymer Preprints 2001, 42(2), 395 in 10% strength by weight aqueous solution only have viscosities of about 150 mPas. The relative viscosity of the polymers according to the invention is more than three times the relative viscosity of the polymers according to the cited literature sources, in each case determined in 1% strength by weight aqueous solution.

The preparation of the polymers according to the invention with a high molecular weight is possible by the rapid addition of the metal salt to a, preferably vigorously stirred, solution of the polymer precursor without metal salt. On a laboratory scale, this corresponds to the stirring power of a magnetic stirrer. The invention thus also relates to a process for the preparation of the above polymers in which non-transition-metal-bridged units of the formula (I), whose charge is balanced by counterions Z, are introduced into a solvent, and are then reacted with salts of the metals M with mixing, where the rate of addition of the metal salts is at least 1 mol/s. Preferably, the rate of addition is at least 2 mol/s, particularly preferably at least 5 mol/s.

In this connection, the concentration of the units of the formula (I) in the solvent prior to the reaction with the metal salts is preferably at least 3% by weight, particularly preferably at least 5% by weight, based on the total solution.

Whereas in accordance with the prior art the metal salt solution is added dropwise to the solution of the unbridged units, according to the invention the metal salt solution is added quickly, or the solution and the metal salts are mixed and reacted directly with one another.

The preparation process according to the invention leads to polymers with a higher molecular weight, as a result of which useful thickening properties are achieved. In addition, the color of the polymers can be modulated through the addition of various metal salts. By adding zinc ions, colorless systems are obtained, by adding cobalt ions, red systems are obtained, by adding iron ions, violet systems are obtained, and by adding ruthenium ions, orange systems are obtained. In addition, hydrogels prepared by the process according to the invention have the advantage that they are switchable. Strong complexing agents which effect greater complex formation than the units of the formula (I) can destroy the polymers since they can remove the metal from the complex. The same effect can be achieved by redox reactions, i.e. by adding oxidizing agents or reducing agents, since the metals only form polymers in certain oxidation states. For example, iron(II) forms polymers, whereas iron(0) and iron(III) do not.

Without wishing to be bound by any one theory, it is possible that through the use of higher telechel concentrations during the synthesis and through an accelerated addition of the metal salt, intermolecular complexing can more likely be achieved in preference to intramolecular complexing. The formation of linear coordination polymers is associated with this.

The units of the formula (I) bridged according to the invention can be bifunctional or multifunctional. Correspondingly, m can have a value from 2 to 100, preferably 2 to 10, particularly preferably 2 to 5, in particular 2 or 3. The index m indicates precisely how many centers suitable for the complexation are available per unit of the formula (I). The units of the formula (I) have terminal substituted pyridyl groups which enter into complex formations with said metals. The two substituents R on the terminal pyridyl groups may, independently of one another, have the given meaning. R, independently of one another, are H, 2-pyridyl, 2-imidazolinyl, 2-imidazolyl, 2-thiazolinyl, 2-thiazolyl, 2-pyridaryl, 2-pyrimidyl, carboxyl, carboxylic ester radical, preferably of C₁-C₁₂-alkanols, carboxamide radical, preferably of ammonia or primary amines, carboxylate, phosphonate, while at least one of the radicals R is different from H. Preference is given to the meanings H, 2-pyridyl, 2-imidazolinyl, 2-imidazolyl, 2-thiazolinyl, 2-thiazolyl.

Preferably, one or both of the radicals R in each terminal structure are 2-pyridyl radicals. Particularly preferably, terpyridine groups are present in terminal positions.

The terminal substituted pyridyl groups are joined to an organic radical A via units—T-[Q-O—]ₙ. The organic radical A here is m-valent, meaning that it carries m substituted pyridyl structures. The radical A can preferably be derived from polyols, polyamines, polyalkanolamines, polyethyleneimine, polyvinylamine and alkoxylates thereof. For example, the organic radical A can be derived from alcohols, amines, esters, amides, such as methyldiethanolamine, triethanolamine, tetraethanolethylenediamine, ethylenediamine, diethylenetriamine, triethylenetetramine, tetraethylenepentamine, polyethyleneimine, glycerol, pentaeritrol, trimethylolpropane, carbohydrates, sorbitol ethoxylates (sorbitan), polyvinyl alcohol, partially hydrolyzed polyvinyl acetates, monohydroxy-, dihydroxy-, trihydroxy-, tetrahydroxy-, pentahydroxy- or hexahydroxybenzenes.

Q, independently of one another, are CHR¹—CH₂ where R¹ is H or optionally substituted C₁₋₆-alkyl. Q is preferably radicals derived from ethylene oxide, propylene oxide, butylene oxide, pentylene oxide or mixtures thereof. Particular preference is given to the radicals Q derived from ethylene oxide or propylene oxide, in particular from ethylene oxide. If various units Q-O are present, the copolymers may be random copolymers, block copolymers or alternating copolymers. Particular preference is given to pure or mixed units derived from ethylene oxide and/or propylene oxide.

Together with the radicals A and T, a structure which is predominantly or exclusively alkoxylates preferably arises. Examples of suitable alkoxylates are polyethylene oxide, polypropylene oxide, polybutylene oxide, poly THF etc.

Suitable trade names of BASF AG are, for example, Lutensol®, Plurafac®, Plurionic®, Pluriol®, Lutron®.

The degree of alkoxylation n is 1 to 10 000, preferably 1 to 1 000, in particular 1 to 500.

Depending on the type of metal ions present in the transition-metal-bridged units, anions Z are necessary for the neutralization. These are present in a number which corresponds to the charge balance within the polymer.

Particularly preferably, apart from the terminal substituted pyridyl groups, only polymerized alkylene oxide units, in particular ethylene oxide units, are present in the units of the formula (I). The terminal substituted pyridyl groups are, in particular, 4-pyridyl groups substituted by 2-pyridyl groups. The structures here correspond to the structures given in the citations from Polymer Preprints. In particular, it is bis(2, 2′:6′, 2″-terpyrid-4′-yl)FeCl₂ poly(ethylene oxide), where 10 to 200, in particular, for example, 180 ethylene oxide units are present in the molecule.

The polymers are prepared according to the invention in a solvent which dissolves both the terminal substituted pyridyl groups and also the linking groups. For example, CHCl₃ is used as solvent since it dissolves the terpyridine moiety and the polyethylene glycol moiety in the preferred units of the formula (I).

The polymers can be used according to the invention for increasing the viscosity of liquids, in particular aqueous or alcoholic liquids, specifically water or alcohols. They can simultaneously be used for imparting color to the liquid. The fields of use for such viscosity-modified liquids have already been discussed in the introduction.

The invention also provides for the use of the polymers as switchable gelling agents (hydrogels) in which the viscosity can be controlled through the addition of complexing agents for the metals M. Such strong complexing agents are sold, for example, by BASF AG under the Triol® trade names.

In such a switchable gel, in particular hydrogel, the viscosity can be controlled. The viscosity is initially adjusted by adding a suitable amount of the polymer. The viscosity is terminated by adding the stronger complexing agent (ligand with higher affinity for the metal ions).

The invention is illustrated in more detail by reference to an example.

### EXAMPLE

The starting materials can be prepared as described in Polymer Preprints 2000, 41(1), 542 to 543 and Polymer Preprints 2001, 42(2), 395 to 396.

### Bis(2,2′:6′,2″-terpyrid-4′-yl)FeCl₂ poly(ethylene oxide)₁₈₀ (7)

300 mg (32.97 μmol) of bis(2,2′:6′,2″-terpyrid-4′-yl)poly(ethylene oxide)₁₈₀ and 4.17 mg (32.97 μmol) of FeCl₂ are introduced into 10 ml of CHCl₃ and stirred at room temperature for 14 h. After the addition of a few drops of MeOH, the mixture is heated to reflux and stirred for a further 28 h. After the solvent has been stripped off, the residue is washed a number of times with diethyl ether. The product is isolated as a violet solid. Yield: 280 mg, (92%); ¹H-NMR (400 MHz, CDCl₃): δ=3.63 (m, 1150H, H-PEO), 4.18 (m, 4H, H-PEO), 5.82 (m, 4H, H-PEO), 7.02-7.90 (m, 8H, H-5,5″, H-6,6″), 9.12-9.23 (m, 8H, H-3,3″, H-3′,5′); UV-Vis (CH₃OH): λₘₐₓ/nm (ε[10⁴ Lmol⁻¹cm⁻)]=244 (4.39), 275 (5.25), 319 (3.66), 559 (1.10); UV-Vis (CH₃OH): λₘₐₓ/nm (ε[10⁴ Lmol⁻¹cm⁻¹)]=245 (4.41), 274 (5.07), 559 (0.97); MS (MALDI-TOF, dithranol): [bis(2,2′:6′,2″-terpyrid-4′-yl)FeCl poly(ethylene oxide)₁₈₀]⁺, 2x[bis(2,2′:6′,2″-terpyrid-4′-yl)FeCl poly(ethylene oxide)₁₃₀]⁺, 3x[bis(2,2′:6′,2″-terpyrid-4′-yl)FeCl poly(ethylene oxide)₁₈₀]⁺, 4x[bis(2,2′:6′,2″-terpyrid-4′-yl)FeCl poly(ethylene oxide)₁₈₀]⁺, 5x[bis(2,2′:6′,2″-terpyrid-4′-yl)FeCl poly(ethylene oxide)₁₈₀]⁺, 6x[bis(2,2′:6′,2″-terpyrid-4′-yl)FeCl poly(ethylene oxide)₁₈₀]⁺.

Through the use of higher telechel concentrations during the synthesis and through an accelerated addition of the metal salt, an intermoleclar complexing was more likely achieved in preference to an intramolecular complexing. The formation of linear coordination polymers associated therewith was detected by reference to the broadening of the (2,2′:6′,2″)-terpyridine signals in the ¹H-NMR spectra and also through the detection of higher mass fragments by means of MALDI-TOF-MS spectrometry. In the mass spectra, signals inter alia in the region of about 20 000, about 30 000, about 38 000, about 48 000 and about 57 000 m/e were observed. By varying the preparation process it was possible to increase the relative viscosities in 1% strength aqueous solutions from originally about 4 to about 13.10% strength aqueous solutions of the coordination polymer formed hydrogels of honey-like consistency. The viscosities were in the region of a few thousand mPas. The modified oligoethylene glycols form high-viscosity metallo-supramolecular coordination polymers with film-forming properties.

1-9. (canceled)

10. A polymer of transition-metal-bridged units of the formula (I) 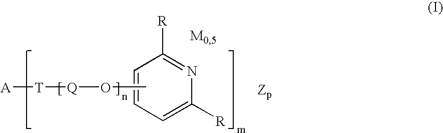
where
A is an m-valent organic radical,
T independently of one another are O or NH,
Q independently of one another are CHR¹—CH₂ where R¹ is H or optionally substituted C₁₋₆-alkyl,
R independently of one another are H, 2-pyridyl, 2-imidazolinyl, 2-imidazolyl, 2-thiazolinyl, 2-thiazolyl, 2-pyridazyl, 2-pyrimidyl, carboxyl, carboxylic ester radical, carboxamide radical, carboxylate, phosphonate, where at least one of the radicals R is different from H,
M is Fe²⁺, Fe³⁺, Co²⁺, Co³⁺, Zn²⁺, Ru²⁺, Os²⁺, Ni²⁺,
Z is SO₄²⁻, CH₃OO⁻, BF₄⁻, SF₆⁻, Cl⁻, I⁻, PF₆⁻, perchlorate,
n is 1 to 10,000,
m is 2to 100,
p is a number which corresponds to the charge balance within the polymer,
where the average molecular weight of the polymer is at least 30,000.

11. A polymer as claimed in claim 10, wherein A is derived from polyols, polyamines, polyalkanolamines, polyethyleneimines, polyvinylamine and alkoxylates thereof.

12. A polymer as claimed in claim 10, wherein R is in each case 2-pyridyl.

13. A polymer as claimed in claim 10, wherein Q is CHR¹—CH₂ where R¹ is H or methyl.

14. A process for the preparation of polymers as claimed in claim 10, which comprises introducing non-transition-metal-bridged units of the formula (I), whose charge is balanced by counterions Z, into a solvent, and then reacting them with salts of the metals M with mixing, where the rate of addition of the metal salts is at least 1 mol/s.

15. A process as claimed in claim 14, wherein the concentration of the units of the formula (I) in the solvent prior to the reaction with the metal salts is at least 3% by weight, based on the total solution.

16. A method of increasing the viscosity of liquids comprising adding the polymer as claimed in claim 10 to a liquid.

17. The method as claimed in claim 16 for simultaneously imparting color to the liquid.

18. A method of controlling the viscosity of the polymer as claimed in claim 10 for use as switchable gelling agents comprising controlling the viscosity of the polymer by the addition of complexing agents for the metals M.
